(19) United States
(12) Patent Application Publication
(10) Pub. No.: US 2019/0038075 A1
(43) Pub. Date: Feb. 7, 2019

(54) OUTDOOR COOKING SYSTEM

(71) Applicant: Paul Cownie, Des Moines, IA (US)

(72) Inventor: Paul Cownie, Des Moines, IA (US)

(21) Appl. No.: 16/057,282

(22) Filed: Aug. 7, 2018

Related U.S. Application Data
(60) Provisional application No. 62/541,874, filed on Aug. 7, 2017.

(51) Int. Cl. A47J 37/07; F24B 7/00

(52) U.S. Cl. CPC A47J 37/0704; A47J 37/0786; F24B 7/005

(57) ABSTRACT

An outdoor cooking system having an elongated horizontal chamber, a vertical chimney that covers a portion of the chamber, and a frame that supports the chamber. The vertical chimney has an inner wall that has an opening that is in communication with the chamber and permits that coals to be easily transferred from the chimney and spread out within the chamber.

### CROSS REFERENCE TO RELATED APPLICATIONS

This application claims the benefit of U.S. Provisional Application No. 62/541,874 filed Aug. 7, 2017, the contents of this application is hereby incorporated by reference in its entirety.

### BACKGROUND OF THE INVENTION

The present invention is directed to an outdoor cooking system and more particularly an outdoor cooking system that combines a fuel burning chimney and a horizontal cooking chamber.

Outdoor cooking systems are well-known in the art. Typically, these cooking systems or grills have a compartment where wood or charcoal is placed and burned to create coals or embers. The coals and embers are then spread out, a grate placed over the compartment, and then food is cooked on the grate. Portable chimneys are sometimes placed within the compartment to facilitate burning of the coals. While useful, these systems are limited in their cooking area and do not permit the heating of coals while simultaneously cooking. Therefore, a need exists in the art for a system that addresses these deficiencies.

An objective of the present invention is to provide an outdoor cooking system having a fixed chimney for burning coals.

Another objective of the present invention is to provide an outdoor cooking system that permits burning coals and cooking food simultaneously.

These and other objectives will be apparent to one having ordinary skill in the art based upon the following written description, drawings, and claims.

### SUMMARY OF THE INVENTION

An outdoor cooking system having an elongated horizontal chamber having a bottom wall, a first end wall, a second end wall, and a pair of side walls. Covering a portion of the chamber is a vertical chimney

The vertical chimney includes the second end wall, side walls, and an inner wall that forms a chute that extends from the bottom wall to a top edge of the chute. The inner wall of the vertical chimney has an opening that permits coals to be transferred from the chimney to the chamber where the coals are spread out for cooking.

The chamber is supported by a frame which has grooves adapted to store a grate.

### BRIEF DESCRIPTION OF THE DRAWINGS

FIG. 1 is a perspective view of an outdoor cooking system;

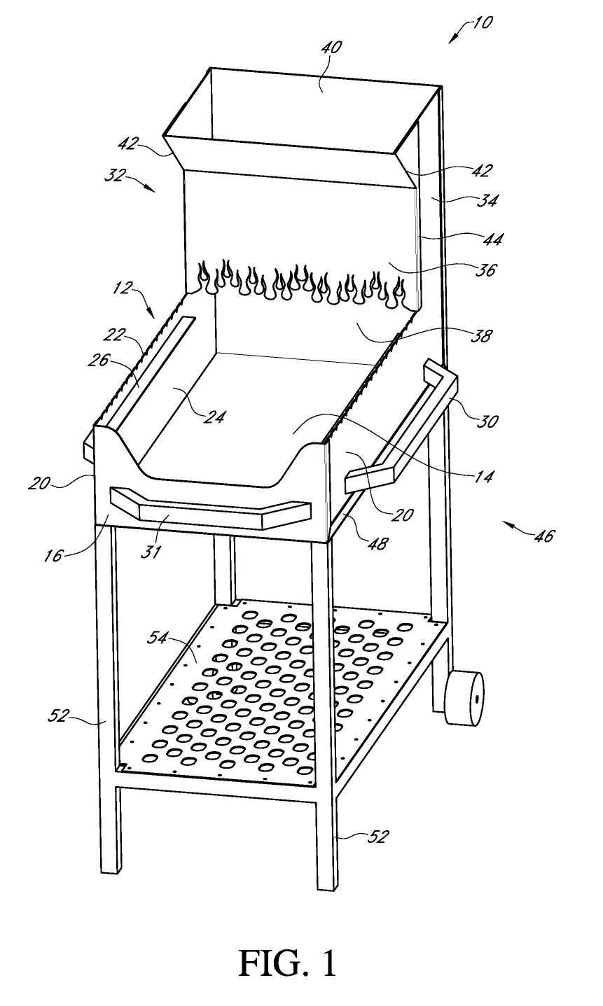

FIG. 2 is a perspective view of an outdoor cooking system; and

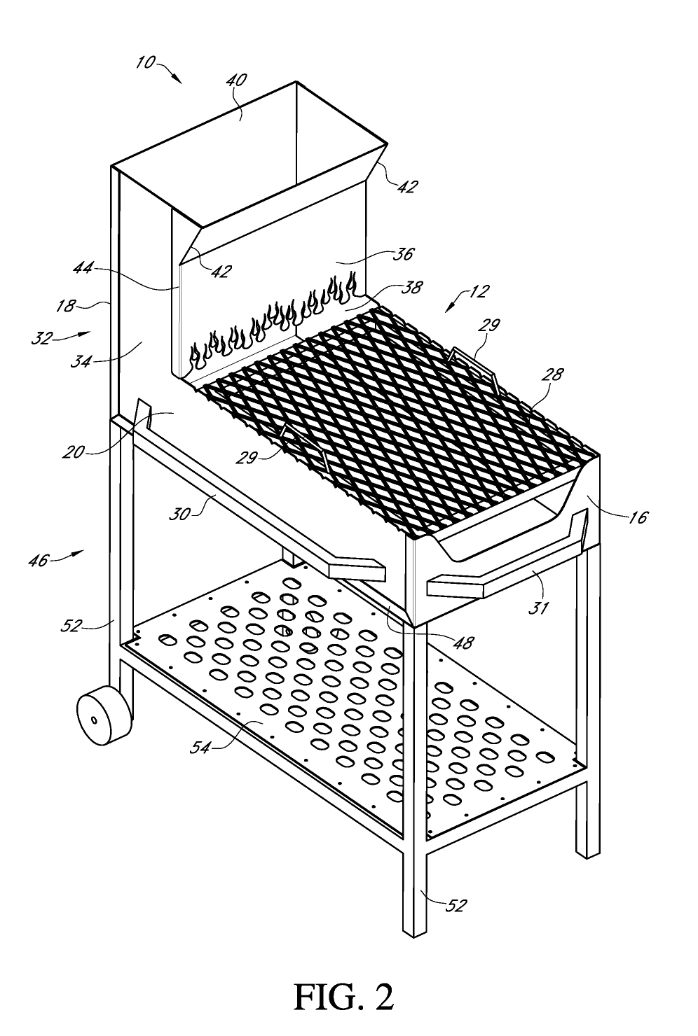

FIG. 3 is a perspective view of an outdoor cooking system.

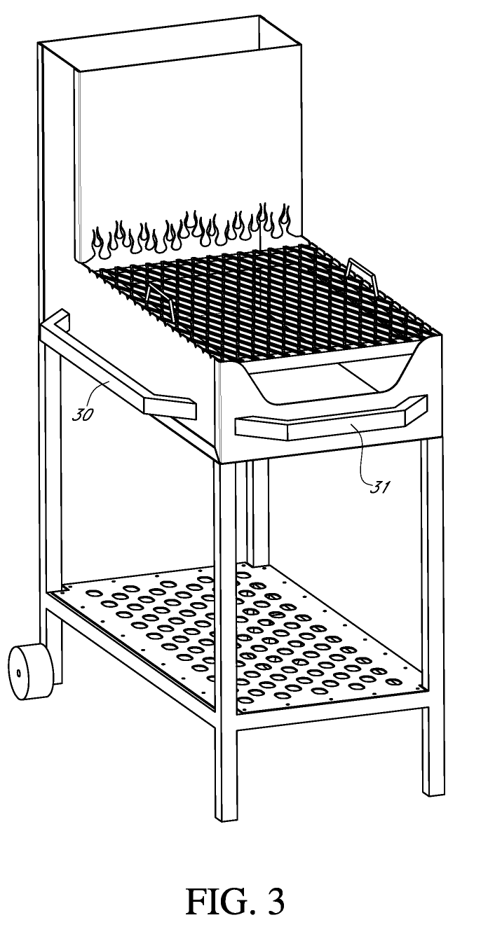

### DETAILED DESCRIPTION OF THE PREFERRED EMBODIMENTS

Referring to the Figures, an outdoor cooking system 10 has an elongated horizontal chamber 12 having a bottom wall 14, a first end wall 16, a second end wall 18, and a pair of side walls 20. In one embodiment, the first end wall 16 has an opening 17 and is pivotally connected to the bottom wall 14. The side walls 20 have an outer member 22 and an inner member 24. The outer member 22 has a height greater than the inner member 24 and the inner member 24 has a width greater than the outer member 22 so that when combined a shoulder 26 is formed within chamber 12. The shoulder 26 supports a removable grate 28 that extends across the chamber 12 from one side wall 20 to the other. The grate 28 has a pair of handles 29. A railing 30 is attached to at least one side wall 20 and a handle 31 is attached to end wall 16.

A vertical chimney 32 extends vertically from and covers a portion of the chamber 12 adjacent the second end wall 18. The vertical chimney is of any size and shape and in a preferred example is comprised of end wall 18, side walls 34 that extend vertically from a portion of side walls 20, and an inner wall 36 that form a chute 38 adjacent the chamber 12, the inner wall 36 has an opening 38 that is in communication with the portion of the chamber 12 not covered by the chimney 32. Preferably, the chimney 32 extends from the bottom wall 14 of the chamber 12 to a top edge 40 of the chimney 32. In one example, the inner wall 36 has a portion 42 that tapers from the top edge 40 toward end wall 18 and then terminates in a generally vertical portion 44.

The horizontal chamber 12 is mounted to and supported by the frame 46. The frame 46 is of any size, shape, and structure. In the example shown, the frame 46 has a pair of side members 48 connected to a pair of end members 50. A plurality of legs 52 are connected to and support the side 48 and end members; wherein the legs are supported by wheels 53. Also, one or more shelves 54 are connected to the legs 52 below the chamber 12. In a preferred embodiment, a pair of grooves 55 are positioned underneath the bottom wall and are configured to receive grate 28.

In operation, fuel material 56 such as wood, charcoal or the like is placed into chute 38 at the top edge 40 to fill a portion of the chute 38. The fuel material 56 is set on fire within the chimney 32 and is burned to produce coals or hot embers. Using a tool 58 similar to a hoe, the hot coals/embers are pulled from the bottom of the chimney 32 through opening 38 and spread across the bottom wall 14 of the horizontal chamber 12. The grate 28 is then placed on the shoulder 26 of side walls 20 and food products 60 are then placed on the grate for cooking.

From the above discussion and accompanying figures and claims it will be appreciated that the outdoor cooking system 10 offers many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. An outdoor cooking system, comprising:
an elongated horizontal chamber having a bottom wall, a first end wall, a second end wall, and a pair of side walls;
a vertical chimney that covers part of the elongated horizontal chamber and is positioned adjacent the second end wall; and
a frame that supports the elongated horizontal chamber.

2. The system of claim 1 wherein the first end wall of the elongated horizontal chamber has an opening and is pivotally connected to the bottom wall.

3. The system of claim 1 wherein the elongated horizontal chamber has a shoulder formed within the elongated horizontal chamber and adapted to support a grate.

4. The system of claim 1 wherein the vertical chimney includes the second end wall, side walls, and an inner wall having an opening in communication with the elongated horizontal chamber that forms a chute that extends from the bottom wall of the elongated horizontal chute to a top edge.

5. The system of claim 4 wherein the inner wall of the vertical chimney has a portion that tapers from the top edge toward the second end wall and terminates in a vertical portion.

6. The system of claim 1 wherein the frame has end members, side members supported by legs, and a pair of grooves positioned underneath the bottom wall of the elongated horizontal chamber adapted to receive a grate.

7. The system of claim 6 wherein the legs are supported by wheels.
